(19) United States
(12) Patent Application Publication
(10) Pub. No.: US 2014/0324457 A1
(43) Pub. Date: Oct. 30, 2014

(54) INTEGRATED HEALTH CARE PREDICTING SYSTEM

(71) Applicants: TaeSoo Sean Kim, Eastchester, NY (US); Kyung Hwa Kim, New York, NY (US)

(72) Inventors: TaeSoo Sean Kim, Eastchester, NY (US); Kyung Hwa Kim, New York, NY (US)

(21) Appl. No.: 13/872,610

(22) Filed: Apr. 29, 2013

(51) Int. Cl. G06Q 50/24; G06Q 10/00

(52) U.S. Cl. CPC G06Q 50/24; G06Q 10/00
USPC 705/3

(57) ABSTRACT

An integrated computerized predicting system is disclosed. A patient computerized system is connected through a web interface to a matching server, where the smart health care matching server is configured to receive a selection criteria from a patient at the patient computerized system. The matching server is connected to an electronic health

(EHR) cloud having electronic health records and a personal health record (PHR) cloud having personal health records. The matching server receives the selection criteria from the patient computerized system, where the matching server includes a smart health care matching system application program. The matching server is configured to utilize the selection criteria, the electronic health records, the personal health records with the smart health care matching system application to predict an appropriate health care professional and/or insurance plans for the patient.

### CROSS REFERENCE TO RELATED APPLICATION

This non-provisional patent application claims priority to U.S. Provisional Patent Application No. 61/640,371 filed on Apr. 30, 2012, which application is incorporated herein by reference.

### FIELD OF THE INVENTION

The present invention relates to an integrated computerized health care predicting system. More particularly a patient is able to obtain the most appropriate health care professional based on this predicting system.

### BACKGROUND OF THE INVENTION

Generally, when a patient goes to see a medical professional her information, the doctor's notes, treatment, diagnosis and other patient information is saved by the doctor in his files. The information the doctor receives makes up the patient's medical records, which may be stored by the doctor in his file cabinet or with the hospital or at the hospital's record keeping company warehouse. Medical records are commonly used in the practice of medicine in order to keep track of a patient's medical history, medical observations, diagnosis and any treatments. The records are useful in accurately determining the patient's medical issue and also prevent a medical professional from prescribing medicine that may be harmful to the patient.

Currently, doctors and medical facilities are able to access and update these medical records, which may be stored remotely on computer servers or on cloud servers. However, when a patient moves from one doctor to another or from one city or state to another she's not able to readily retrieve her medical records electronically without obtaining authorization from her previous doctor. These medical records are usually stored as electronic records on the computer servers or cloud servers. This doctor's authorization may be difficult to obtain because the doctor or hospital may be very restrictive in granting access to a patient or other health care professional. Presently, medical records are treated as being owned by the medical offices or institutions where the medical records are housed so the patient and health care professionals are prevented from easily accessing these records.

There are several automated medical record systems that have been utilized for the health care field. These medical record systems include U.S. Pat. No. 5,277,188 that discloses a clinical information reporting system having an electronic database including electrocardiograph related patient data. Also, there is U.S. Pat. No. 5,099,424 that discloses a computer system for recording electrocardiograph and/or chest x-ray test results for a database of patients. Next, there is U.S. Pat. No. 7,798,254 that is a method and system of managing medical and biographical records and providing medical diagnosis.

These medical records in the aforementioned inventions are useful, but their usefulness is not fully realized in order to help a patient in seeking further medical treatment. The aforementioned inventions discuss accessing electronic records in order to manage medical and biological records, but they don't include utilizing these records in order to assist a patient in seeking further treatment. In addition, these inventions do not provide a method for enabling the patient to choose a health care professional based on the medical and biological records. The utilization of the medical and biological records can possibly provide the patient with a more appropriate health care professional than she can presently find on her own, which means she may be able to obtain better treatment by utilizing these records.

Therefore, there is a need for a system that enables a patient to utilize their medical and biological records in order to obtain an appropriate health care professional who may provide her better treatment than she may otherwise receive.

### SUMMARY OF THE INVENTION

The present invention has been accomplished in view of the above-mentioned technical background, and it is an object of the present invention to provide a computerized system for predicting an appropriate health care professional for a patient.

In one aspect of the invention, an integrated computerized predicting system is disclosed. A patient computerized system is connected through a web interface to a matching server where the matching server is configured to receive selection criteria from a patient at the patient computerized system. The matching server is connected to an electronic health record (EHR) cloud server having electronic health records and a personal health record (PHR) cloud having personal health records of the patient. The matching server receives the selection criteria from the patient computerized system, where the matching server includes a smart health care matching system application program. The matching server is configured to utilize the selection criteria, the electronic health records, the personal health records with the smart health care matching system application program to predict a health care professional and/or insurance plans for the patient.

In another aspect of the invention, a computer-implemented method of updating health care records is disclosed. The computer-implemented discloses: providing an electronic health record on an electronic health record cloud; providing a health care professional access to the electronic health record on the electronic health record cloud; determining at a health care professional computer system if the electronic health record at the electronic health record cloud should be modified for at least one patient by the health care professional; providing authorization from a permission based server to the health care professional with permission to modify the electronic health record of the at least one patient; modifying the electronic health record of the at least one patient through the health care professional computer system; and automatically synchronizing the modified electronic health record based on permitted data allowed by the permission based server between the electronic record of the electronic health record cloud and a personal health record of the personal health record cloud.

In another aspect of the invention a computer-implemented method of updating health care records is disclosed. The computer-implemented method discloses: providing a personal health record on a personal health record cloud; providing a patient with access to the personal health record on the personal health record cloud; determining at a patient health care computer system if the personal health record at the personal health record cloud should be modified for the patient; modifying the personal health record of the patient through the patient health care computer system; and automatically synchronizing the modified personal health record with a personal health record on the patient health care computer system.

### BRIEF DESCRIPTION OF THE DRAWINGS

These and other advantages of the present invention will become more apparent as the following description is read in conjunction with the accompanying drawings, wherein:

FIG. 1 is a block diagram of an integrated computer system of a smart health care matching system in accordance with the invention;

FIG. 2 is a flow chart of how a patient utilizes the integrated computer system of the smart health care matching system of FIG. 1 in accordance with the invention;

FIG. 3 is a flow chart of how a doctor utilizes the integrated computer system of the smart health care matching system of FIG. 1 in accordance with the invention;

FIG. 4 shows an example main page of a webpage of the smart health care matching system of FIG. 1 in accordance with the invention;

FIG. 5 shows an example of a webpage of a typical doctor from the smart health care matching system of FIG. 1 in accordance with the invention;

FIG. 6 shows an example of a webpage of a profile of a patient from the smart health care matching system of FIG. 1 in accordance with the invention;

FIG. 7 shows an example of a webpage of an appointment for the smart health care matching system of FIG. 1 in accordance with the invention; and

FIG. 8 is a flow chart of how the SHCMS application program is utilized by a patient in accordance with the invention.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

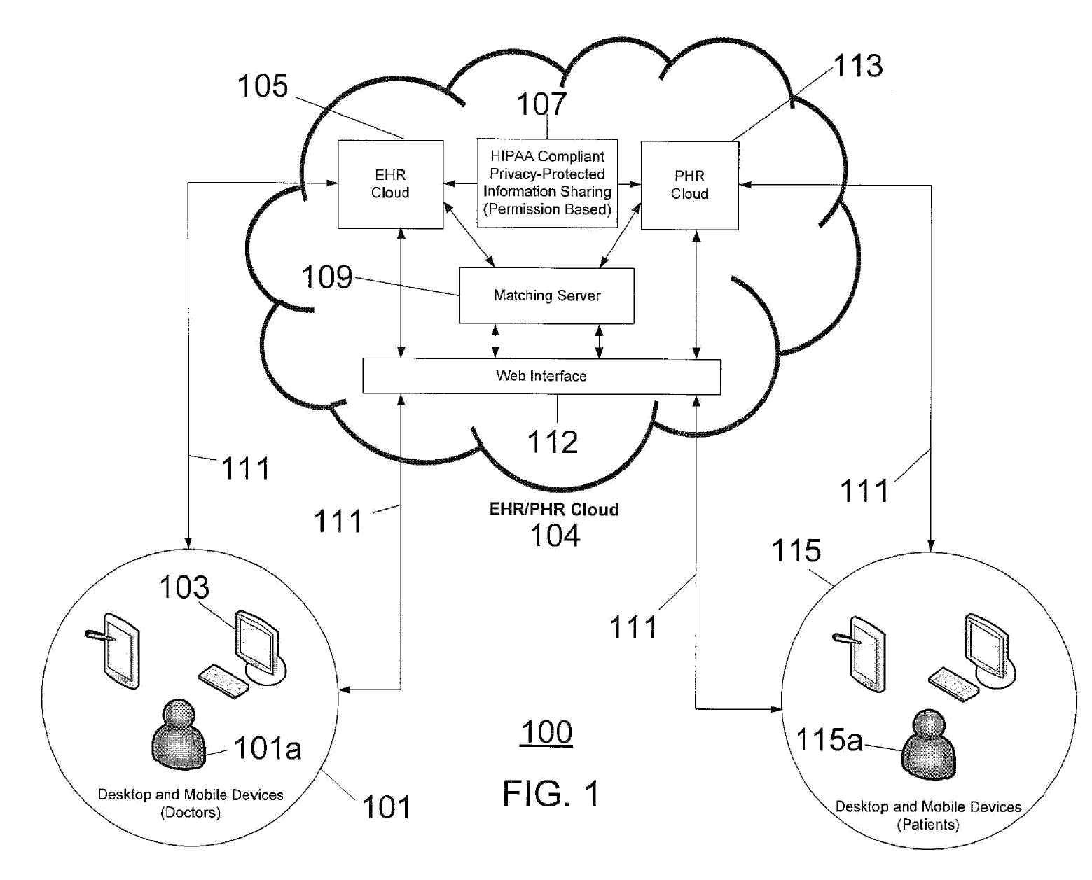

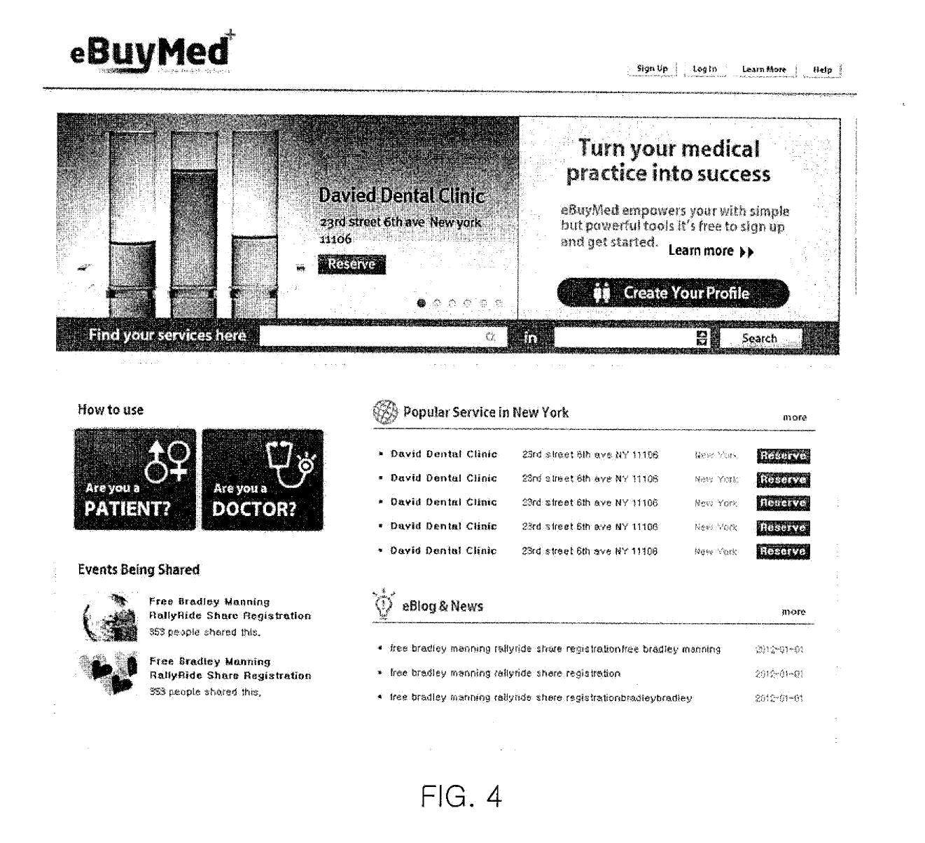

FIG. 1 is an illustration of a block diagram of the integrated computer system of the smart health care matching system. The smart health care matching system or integrated computer system 100 may also be known as an eBuyMed system. Computer system 100 includes a doctor/health care professional computer system 101, an Electronic Health Record/Personal Health Record Cloud system 104 and a patient health care professional computer system 115. Electronic Health Record/Personal Health Record Cloud System 104 (EHR/PHR cloud system 104) includes Electronic Health Record (EHR) cloud 105, permission based server 107, matching server 109, Web interface 112 and Personal Health Record (PHR) 113. When a health care professional 101a or a patient 115a is able to access the web interface 112 through Internet 111, then the health care professional 101a or the patient 115a will see the main page website shown in FIG. 4. On this website, the patient 115a is able to access her information by utilizing the computer 115 to click on the Icon “Are you a Patient?” The health care professional 101a will also be able to utilize this site when he uses a computer 103 to click on the Icon “Are you a Doctor?”

Returning to FIG. 1, health care professional system 101 and the patient health care computer system 115 is connected through a communication link, such as Internet 111 to the Electronic Health Record/Personal Health Record Cloud System 104. The communication link may be a local access network (LAN), wireless access network, wide area network (WAN), a virtual area network, wireless fidelity (Wi-Fi) network, Bluetooth, an Ethernet link, a satellite link, cable link, cellular, fiber-optic or any network that can facilitate the transfer of information between computer systems.

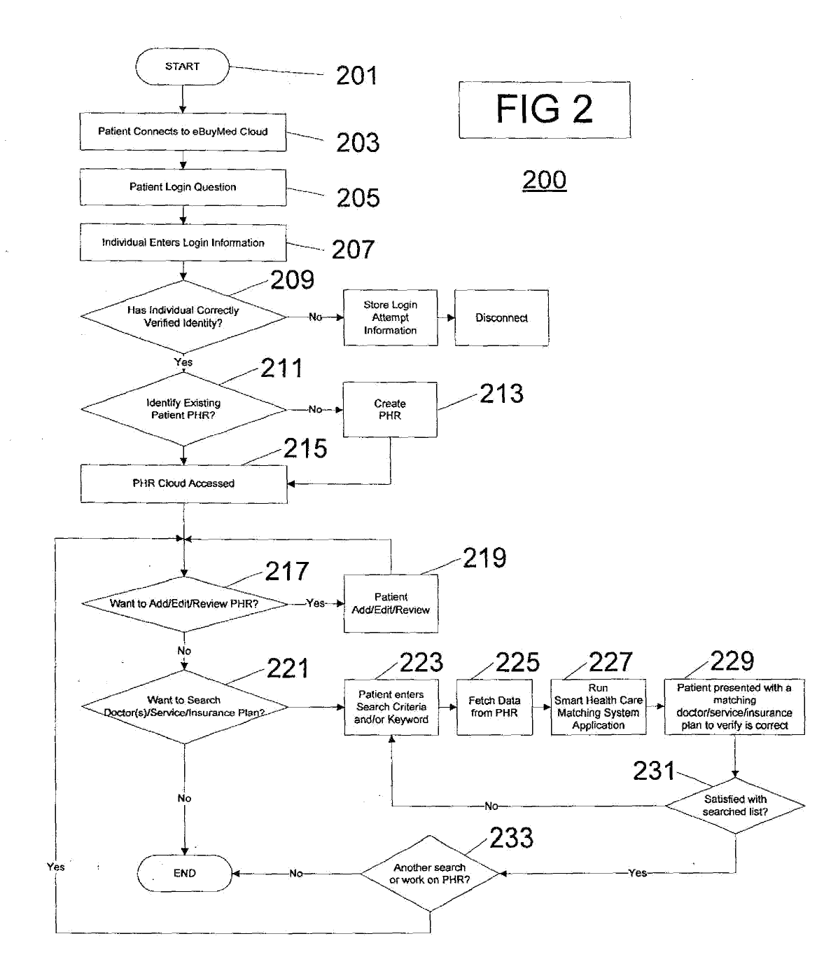

Health care professional computer system 101 includes an actual health care professional 101a that utilizes the computer 103. Health care professional 101a may be a general practitioner doctor, obstetrician, gynecologist, psychologist, psychotherapist, nurse, dentist, emergency medical professional, pharmacist or any medical professional. Computer 103 may be any type of computer system including a desktop, laptop, notebook, mobile computer system, a tablet computing system, cell phone, smartphone or any type of computing system. Computer 103 is connected to Internet 111 or global network 111, which connects it to the electronic health record (EHR) cloud 105, matching server 109, permission based server 107 and personal health record (PHR) cloud 113. Matching server 109, permission based server 107 are equivalent to a typical computer system that includes a processor, mass storage and memory. The matching server 109 also includes a smart health care matching system software program stored on the processor which will be described in FIG. 2.

EHR cloud 105 includes medical and biological records for different patients that received treatment from the health care professional 101a it also services in which resources are retrieved from the Internet 111 through web-based tools and applications, rather than a direction connect to a server. Also, EHR cloud 105 provides a collection of electronic health information about users or patients on a HIPAA-compliant eBuyMed cloud Network Server also referred to as permission based server 107. A user or patient can input and keep a record of patients' medical information including demographics, medical history, medication, allergies, immunization status, laboratory test results, radiology images, vital signs, billing and insurance information on the EHR cloud 105. Also, EHR cloud 105 includes an EHR record of the services offered by the doctor including fever, cold, heart diseases and a list of the doctor's contacts.

EHR cloud 105 also allows for there to be secure communication with patients via encrypted message feature and tele-health consultation via visual video communication. EHR cloud 105 will have the capacity to automatically sync with patient's PHR records stored in PHR cloud 113 subject to privacy settings and permission data settings on permission based server 107. The data and storage packages are stored on the servers. The cloud computing structure of EHR cloud 105 allows the patient or doctor to have access to information as long as the patient or doctor is connected to an electronic device, such as a computer or cell phone that has access to the Internet or World Wide Web.

PHR cloud 113 includes medical and biological records relating to a particular patient that has his or her information stored there. The personal health record also includes: history of a disease of the patient, history of doctor appointment of the patient, preference of doctors for the patient, home address for the patient, a patient budget and other patient information.

EBuyMed personal health records on PHR cloud 113 will provide collection of electronic health information about patient's medical records on a HIPAA-compliant eBuyMed permission based server 107. Patient 115a will be able to input and keep a record of her medical information such as demographics, medical history, medication, allergies, immunization, status, laboratory test results, radiology images, vital signs, billing and insurance information. PHR cloud 113 will also allow secure communication with patients via encrypted message feature and tele-health consultation via visual video communication. PHR cloud 113 has the capacity to automatically sync with treating health care professional's EHR records at EHR cloud 105 subject to privacy settings stored on EHR cloud 105 and permission data setting on permission server 107. Similar to EHR cloud 105, PHR cloud 113 is a place where its resources are retrieved from the internet through web-based tools and applications.

Patient health care computer system 115 may be any type of computer system including a desktop, laptop, notebook, mobile computer system, a tablet computing system, cellular phone, smartphone or any type of computing system. The patient health care computer system 115 is similar to the health care professional computer system 101 where its connected through the global network 111 to the PHR cloud 113, permission based server 107, EHR cloud 105, and smart health care matching server 109.

Health care professional 101a interacts with the health care professional computer system 103 in order to access the global network 111 and the EHR cloud 105. The global network 111 conducts authentication and allows profile update, view or edit of full EHR records permission setting. When the health care professional 101a information is verified then she can access the medical and biographical records contained in the EHR cloud 105. Health care professional 101a sets the permission based information sharing server 107 for PHR cloud 113 and EHR cloud 105 information sharing. The permission based information sharing server 107 is a typical information sharing component that allows certain information to be shared between the EHR cloud 105 and the PHR cloud 113. For example, the permission based information sharing server 107 may be HIPAA (Health Information Portability Account Act) compliant in that it only allows information approved by HIPAA to be shared between the EHR cloud 105 and PHR cloud 113, for example such as information associated with a car accident but no sharing of gynecological information between the EHR cloud 105 and PHR cloud 113.

Next, the health care professional 101a may utilize the matching server 109 to select an appropriate health care professional for a patient. When the health care professional computer system 101 is connected to the EHR cloud 105, the computer system 101 automatically updates or synchronizes itself with the information contained in the EHR cloud 105. Thus, any new information inputted by the health care professional system 101 is automatically synced to the EHR cloud 105.

Patient provider 115a interacts with the patient health care computer system 115 in order to utilize the global network 111 to access the PHR cloud 113. The global network 111 conducts authentication and allows profile update, view or edit of full PHR or permission setting. When the health care professional 101a information is verified then she can access the medical and biographical records contained in the PHR cloud 113. Patient provider 115a sets the permission based information sharing server 107 for PHR cloud 113 and EHR cloud 105 information sharing. The permission based information sharing server 107 is a typical information sharing component that allows certain information to be shared between the EHR cloud 105 and the PHR cloud 113. For example, the permission based information sharing 107 may be HIPAA compliant in that it only allows information approved by HIPAA to be shared between the EHR cloud 105 and PHR cloud 113, for example such as information associated with a car accident. Next, the patient 115a may utilize the matching server 109 to predict or match with an appropriate health care professional. When the patient computer system 115 is connected to the PHR cloud 113 it automatically updates or synchronizes itself with the information contained in the PHR cloud 113. Thus, any new information inputted by the patient provider system 115a is automatically synchronized with the PHR cloud 113.

FIG. 2 is a flow chart of how the patient utilizes the computer system of the smart health care matching system. At block 201, a patient connects to the health care matching system or eBuyMed system by utilizing the patient provider computer system 115 (FIG. 1) that utilizes the Internet 111 and authentication system to connect to the PHR cloud 113. At block 203, the patient provider computer system 115 provides the patient with a Login Question in order to allow the patient to connect to the eBuyMed system. The Login Question is “What is Your Username and Password?” The patient 115a utilizes the patient provider computer system 115 to connect through the Internet 111 to log onto the web interface 112 in EHR/PHR Cloud 104. Web interface 112 conducts authentication and allows profile update, view or edit full PHR entries, view partial EHR permission setting.

At block 205, the patient 115a accesses the PHR cloud 113. The patient 115a sets permissions setting for PHR-EHR information sharing by only allowing certain information to be shared between PHR cloud 113 and HER cloud 105. For example, the certain information may be the patient's name, address, date of birth, treatment outcome, treatment charts, insurance and doctors used. But the information not shared may be any HIV tests or venereal disease tests taken by the patient 115a and the results of these tests unless it is otherwise stipulated in the privacy setting of permission based information sharing server 107. Patient 115a may be provided with a drop screen to input information they want to be shared from PHR cloud 113 to EHR cloud 105 and information that should not be shared from PHR cloud 113 to EHR cloud 105.

At block 207, the patient 115a utilizes the computer 115 to enter her individual login information that is transmitted through the Internet 111 and web interface 112 to the PHR cloud 113. The login information may include the patient's first name, middle name, last name, date of birth, specific ailments, treating doctors etc. At block 209, the PHR cloud 113 determines if the individual identity is correctly identified by comparing the inputted username and password to the stored username and password on EHR cloud 105 to see if there's a match. If the individual is not correctly identified then this individual login information is stored then this process ends.

If the individual login information is correctly identified, then this process continues to block 211. Then at block 211 there is a determination if there is an identification of the existing patient information stored on PHR cloud 113 with the individual login information. If there is no match then at block 213 a PHR is created for the individual login information and stored on PHR cloud 113 then the process continues to block 215. However, if there is a match between the individual login information with a personal health record stored on PHR cloud 113, then the process continues to block 215 where the patient is given access to PHR cloud 113.

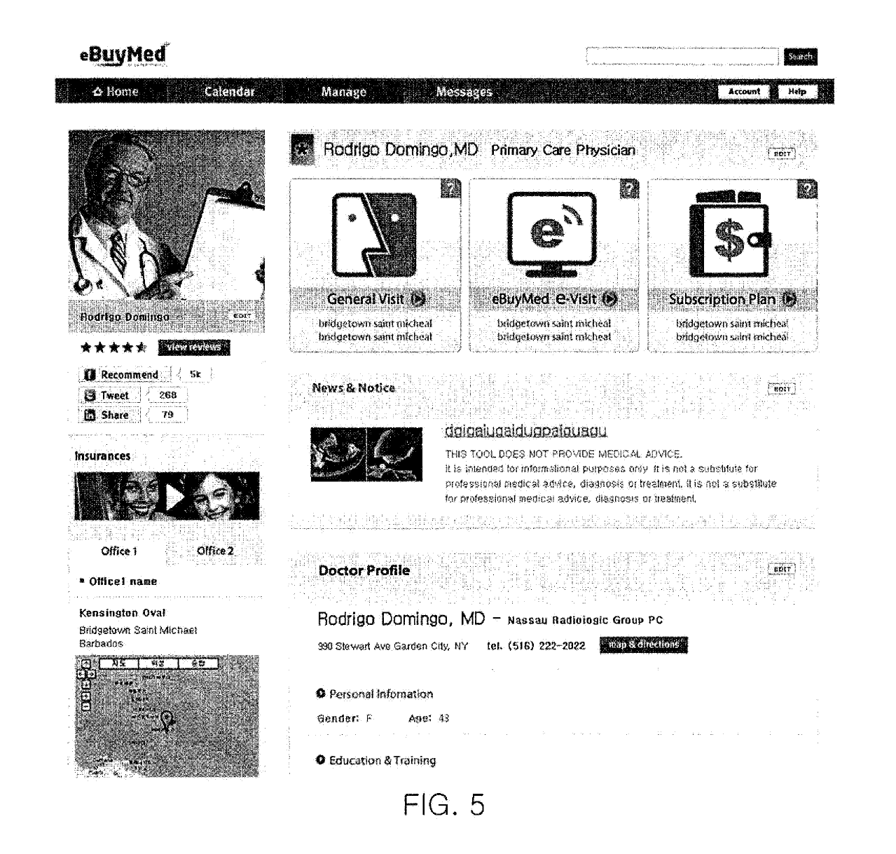

Next, at block 217 there is a determination if there is a need to add, edit or review the personal health record on PHR cloud 113. If there is a need to add, edit or review the personal health record on PHR 113 then at block 219 the patient is able to add, edit or review the information, which will be automatically synchronized with the patient health care computer system 115. However, if there is no need to add, edit or review the personal health records on PHR cloud 113 then the process continues to block 221. At block 221, there is a determination if there is a want to search doctor(s) or service(s) or insurance plan(s). If there is no want to search for a doctor, service or insurance plan then the process ends. However, if there is a want to search doctor, service or insurance plan then the process goes to block 223 where the patient 115a enters search criteria for selection criteria and/or keyword on the patient health care computer system 115, which is then transmitted to the matching server 109 then the process goes to block 225. The search criteria may include the doctor's area of expertise, the patient medical insurance, types of surgeries and type of patient service requested. The doctor's area of expertise may include breast cancer, types of surgery, success rate etc. The doctor may be a general practitioner, dermatologist, an obstetrician, gynecologist or any type of doctor. For example, the patient may be able to access the webpage of a doctor as shown in FIG. 5 where the doctor's personal information is shown so the patient can review the profile of her potential doctor.

Referring to FIG. 2, at block 225, the patient's data is obtained from PHR 113 and transmitted to the matching server 109, and then the process continues at block 227. At block 227, the matching server 109 (FIG. 1) is able to operate in order to predict or match the patient with the best matched doctors or best health care professional. The matching server 109 includes a Smart Health Care Matching System (SHCMS) application program.

Smart Health Care Matching System (SHCMS) is a server-side software program that searches doctors that are predicted to give maximum satisfaction and best treatment outcome for each patient. SHCMS application program calculates this prediction based on (1) patient's PHR and health care professional's EHR records (2) previous history and reviews from other patients, and (3) patient inputted information. Patient connects to the system via client-side program such as Internet browsers on their computer or mobile devices. The patient will input basic information to search for health care professionals (e.g., area, diseases). Existing systems only search health care professionals from their database using those search criteria and simply return a list, which contains numerous numbers of health care professionals. Considering the number of health care professionals in a given city, it is not helpful or most efficient to provide entire list of health care professionals based on this simple searching mechanism without further customization for each patient. In addition to the search criteria that the patient enters, SHCMS application program utilizes existing PHR records on PHR cloud 113 for ideally matched health care professionals for the patient. Finally, SHCMS application program incorporates other patients' history on EHR record on EHR cloud 105 of SHCMS application program results and consider patients' feedback on EHR records when the doctors are recommended via SHCMS application program. To achieve these approaches, this novel matching system, SHCMS application program, leverages a customized Machine Learning technology.

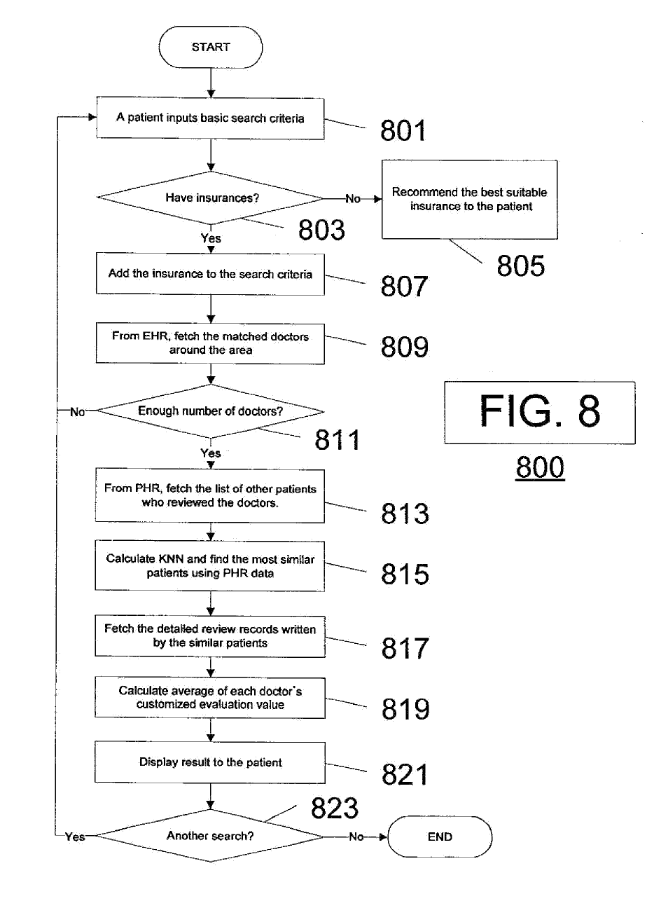

FIG. 8 shows the SHCMS application program is utilized by a patient. At block 801, patient 115A inputs basic search criteria (area and disease). Then, at block 803 SHCMS applicant program automatically retrieves the patient's current insurance type to determine if the patient 115a has insurance. If the patient 115a does not have any insurance, then at block 805 the SHCMS application program recommends best suitable or most popular insurance for her based on location, demographic, and other variables in patient PHR cloud 113. At block 807, the SHCMS application program adds the insurance type to the search criteria. Simultaneously at block 809, the SHCMS application program fetches matched health care professional and insurance list from EHR cloud 105 (e.g., all the dentists in 3 miles distance from Manhattan, who accepts Type A insurance).

In order to find the best-predicted or matched health care professional for the patient this system utilizes information stored in the EHR cloud 105 and PHR cloud 113 that includes patient-doctor ratings. The patient can rate health care professionals after their visit and treatment. At block 811, the SHCMS application program determines if enough doctors were chosen from EHR cloud 105. If there are not enough doctors chosen, such as only 1 doctor being chosen then the process goes to block 801. However, if there are enough doctors chosen, such as 2 or more doctors, then the process continues to block 813. At block 813, this application searches the best-predicted matched health care professionals stored on the EHR cloud 105 for each patient on PHR cloud 113 to provide the patient with information on the matched health care professionals. In addition, the same mechanisms can be used to predict the most appropriate health insurance plan for the uninsured patients based on demographics, such as region, income level, age and sex.

SHCMS application program utilizes a customized Machine Learning Strategy in order to match the health care professional or insurance plans with the patient, which includes several unique features. First, the system refers to the medical and treatment history stored on electronic health records of both health care professional and patient to recommend the health care professional for the patient. For example, if a patient already had a special disease in their personal health records stored on PHR cloud 113 and she is searching a doctor for another disease now, the SHCMS application program will recommend a health care professional who is an expert of those two diseases using EHR data from EHR cloud 105. Second, the SHCMS application program is self-evolving, which means that it actively leverages several modern technologies in current Machine Learning (ML) area. The EHR cloud 105 stores patient-doctor matching and record every patient's feedback (a rating number from 0 to 5) about satisfaction of this matching, which is reported after treatment is received and collects actual outcome of the treatment from the patients PHR records at PHR cloud 113 and health care professional's electronic health records at EHR cloud 104. The numeral 0 represents the worst rating while the numeral 5 represents the best rating.

The predicting or matching results, patient feedback and treatment results are then accumulated and used as training sets for the Machine Learning algorithm. The more number of data sets that are collected, the more accurate predictions of best matched health care professionals for each patient can be given by SHCMS. Lastly, the Machine learning approach can distinguish the detailed rating of each health care professional. For example, assume that a health care professional has average 3 stars out of 5 stars as the rating from their patients. Existing systems would simply handle this doctor as a 3-star health care professional, but it is possible that she has received 2 stars from all the patients who had “disease A” and 4 stars from other patients who had “disease B”. In this case, when a new patient searches a health care professional due to the “disease A”, SHCMS application program will recommend another health care professional who received higher feedback for “disease A”. This SHCMS application program considers not only disease but also various patients' profiles such as sex, age, area, and ethnicity.

For Table 1, the patients' information is utilized for the SHCMS Machine learning algorithm in order to select the best health care professional for the patient. In this table, a patient that is a 17 year old male that has disease A has been treated by a doctor that's 52 years old who is specialized in disease A and accepts Type A insurance. The patient provides the doctor with a rating of 3.5 out of 5. The next patient is a 32 year old female that has no disease A and has been treated by a doctor that is 42 years old doctor who accepts type B insurance. The patient gives the doctor a 2.5 out of 5 rating. Another patient is a 20 year old female has been treated by a doctor that is 31 years and accepts type C insurance. The patient gives the doctor a 5 out of 5 rating. The last patient is a 55 year old male that has been treated by a doctor that is 49 years and accepts type C insurance. The patient gives the doctor a 1 out of 5 rating. All of this information is stored on the EHR cloud 105, and then transferred to the matching server 109 in order to predict health care professional who is calculated to give best quantifiable treatment outcome for that patient.

TABLE 1

| Input Variables | | | | | | | | |
|---|---|---|---|---|---|---|---|---|
| | | | Variable N | Doctor | Doctor | | Doctor | Output |
| Variable 1 | Variable 2 | | (disease | Variable 1 | Variable 2 | | Variable N | Feedback |
| (age) | (sex) | . . . | X) | (Specialty) | (age) | . . . | (insurance) | (Evaluation) |
| 17 | M | | Yes | Disease X | 52 | | Type A | 3.5 |
| 32 | F | | No | Disease Y | 42 | | Type B | 2.5 |
| 20 | F | | No | Disease Z | 31 | | Type C | 5.0 |
| 55 | M | | No | Disease X&Y | 49 | | Type C | 1.0 |

The detailed steps of matching mechanism are as follows:
1. A patient input basic search criteria (area and disease) as stated above in block 801. Then, SHCMS application program automatically retrieves the patient's current insurance type and add the insurance type to the search criteria as stated above in blocks 803 and 807. If the patient does not have any insurance, SHCMS application program recommends best suitable insurance for her as stated above in block 805. Then, SHCMS application program fetches matched doctor list from EHR cloud (e.g., all the dentists in 3 miles distance from Manhattan, who accepts Type A insurance) as stated in block 809.
2. If enough number of matched health care professionals are found as stated above in block 811, for each candidate health care professionals obtained in then the SHCMS application program 1) fetches/obtains the review records, which have been inserted by other patients who were treated by those health care professionals from the feedback table in the PHR cloud 105, as stated above in block 813, A health care professional identifier is utilized to fetch correct record from the review records.
3. For each dataset obtained from 2, find a number of similar patients who reviewed the health care professional and whose attributes are similar to the customer at block 815. To find out the similar patients, several machine learning algorithms can be used. SHCMS application program utilizes one of the well-known machine learning methods, Supervised Learning. Trevor Hastie, Robert Tibshirani and Jerome Friedman, “The Elements of Statistical Learning”, Springer-Verlag, Chapter 1, 2001, ISBN-10: 0387952845 which is herein incorporated by reference. Generally, the goal of supervised learning is to predict the output y for an unseen test example x given training data {(x1, y1), . . . ,(xN , yN)}. Xi is a vector consisting of input features or attributes. In this system, training data set is reviews of doctors, which are written by patients who were actually treated by the health care professionals. The X, (input attributes) consists of profile data of patients and Y (output) is sum of feedback rating of doctor (number from 0 to 5) and outcome of treatment based on patients' PHR and doctor's EHR records (treatment result from 0 to 5). Y is named “eBuyMed's Evaluation”. (FIG. 1). The present possible input vector (x vector) in the next section. The input vector can be composed of all variables in the next section or subset of those variables.
   F=Normalize(patient's feedback)
   P=Normalize(outcome of treatment from PHR)
   E=Normalize(outcome of treatment from EHR)

Y(eBuyMed's Evaluation)=F+P+E

Y (eBuyMed's Evaluation) is the final evaluation number which is calculated by sum of combination of normalized scores of patients' feedback, quantified outcome of treatment from PHR, and quantified outcome of treatment from EHR. This evaluation number is also exposed to the patients who are searching the health care professionals at the eBuyMed website.

The Machine Learning variables are as follows:
1) From Patients' Profile: location, ethnicity, age, sex and budget;
2) From Patients Health Record (PHR): Allergies, Medical Condition, Medication, Immunization, Family History, Habits;
3) From health care professional's Electric Health Record (EHR): Diagnosis, prescription, treatment, and treatment outcome; and
4) From eBuyMed History: Recommendation, Wait Time, Insurance Plan, and Treatment Costs.

One example of the Machine Learning Language algorithm used to select the best health care professional for the patient utilizes the customized K-Nearest Neighbor (KNN) algorithm at block 817. KNN algorithm is an intuitive algorithm which can find out similar data set from training data. KNN needs X vector which consists of input value and Y vector (output values). Other Machine Learning Language algorithms may be used in this application.

Input vector: All variables mentioned above

Output vector: “eBuyMed's Evaluation” (Quantified evaluation of SHCMS's doctor-patient matching)

Algorithm parameters:

K: number of nearest neighbors (similar patients) to find out. K can be changed for the most efficient results.

d: distance between neighbors (patients)

$$d ( {X}_{i} , {X}_{j} ) = \sqrt{{\sum }_{m = 1}^{D} {( {X}_{im} - {X}_{jm} )}^{2}}$$

There are several ways to compute distance. There is a combination of two intuitive distance algorithms:
1) Euclidean distance (above). For the equation above, d(xi, xj) calculates how much two patients (xi and xj) are similar to each other. (Xim is mth element in Xi vector, D is number of element in a vector Xi). Euclidean distance is used for real-valued features.
2) Hamming distance for binary-valued features is utilized for the equation below. For example, sex type cannot be presented as a number. In this case, there is a calculation of the distance by counting how many times the elements in two vectors disagree.

$$d ( {X}_{i} , {X}_{j} ) = {\sum }_{m = 1}^{D} I ( {X}_{im} \neq {X}_{jm} )$$

We can also assign weights to features:

$$d ( {X}_{i} , {X}_{j} ) = {\sum }_{m = 1}^{D} {w}_{m} d ( {X}_{im} , {X}_{jm} )$$

Equations from: Hui Wang, “Nearest Neighbors by Neighborhood Counting” IEEE TRANSACTIONS ON PATTERN ANALYSIS AND MACHINE INTELLIGENCE, VOL. 28, NO. 6, 2006, this is herein incorporated by reference.
4. After determining the similar patients, SHCMS application program calculates average of “eBuyMed's evaluation” obtained from the similar (k-nearest) patients' review records at block 819. At block 821, patient computer system 115 displays a customized list of health care professionals who received the highest average of “eBuyMed's evaluation” from those selected patients. In other words, SHCMS application program chooses the best matched health care professionals using customized feedback list which is composed of review records of similar patients and SHCMS application program's unique evaluation mechanism. At block 823, SHCMS application program asks the patient 115a if she wants to conduct another search for health care professionals. If she wants to continue searching for health care professionals and/or insurance plans, then the process returns to block 801. However, if she doesn't want to continue looking for a healthcare professional and/or insurance plan then the process ends.

Returning to FIG. 2, after the health care professional or insurance list is selected at the matching server 109 at block 227 then the process goes to block 229. At block 229, the process then continues where the patient 115a is presented with a matching health care professional or service to verify if it is correct by the matching server 109 transmitting through PHR cloud 113 a display on the patient computer system 115 of the matching health care professional for the patient 115a to choose.

Next, at block 231 the patient health care computer system 115 determines if the patient 115a is satisfied with the health care professional or insurance list by displaying a question “Are you satisfied with the health care professional or insurance list” on the display of the patient health care computer system 115. The patient would use a keyboard or mouse of the patient computer system 115 to state the health care professional list, service list or insurance list is not satisfactory. If the patient states that searched health care professional, service or insurance plan list is not satisfactory then the process returns to block 223 to search again. However, if the patient is satisfied with searched doctor or service or insurance plan list then the process continues to block 233.

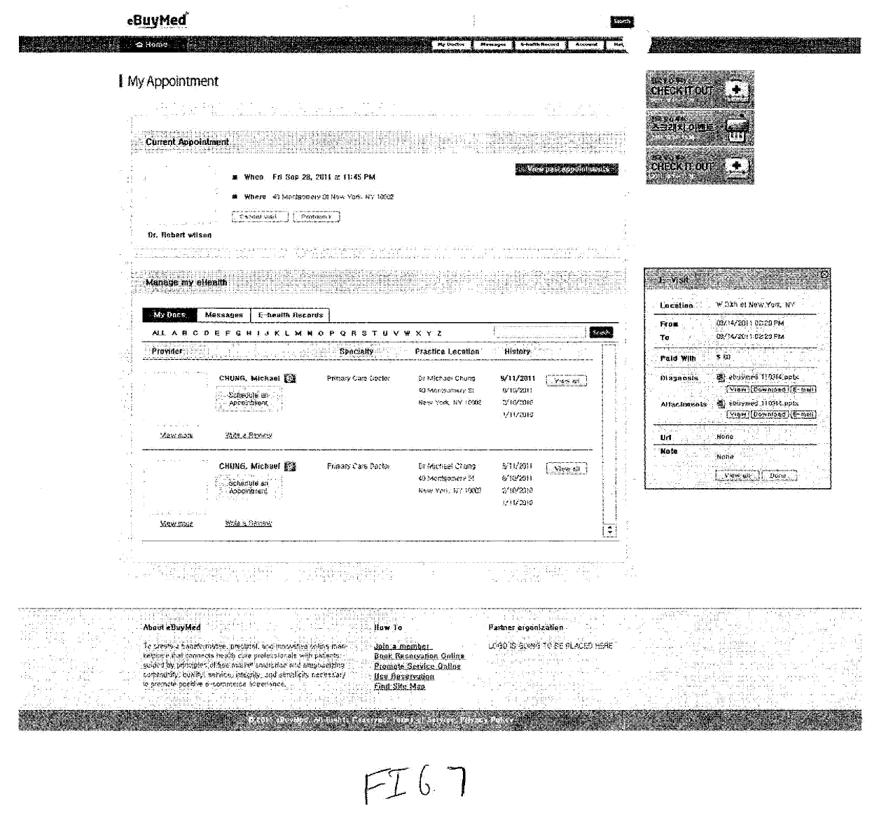

At block 233, there is a determination if there should be another search or work on PHR 113. The other work may be to set up an appointment with a doctor that was chosen by making an appointment as shown in FIG. 7 where the patient is able to make an appointment to see the doctor. The other search may be a New Need or Another Need for medical care, health care professional or insurance plans. Returning to FIG. 2, if there is a determination that there should be another search or work on PHR 113 then the process returns to block 217. However, if there is a determination that there should not be another search or work on PHR 113 then the process ends.

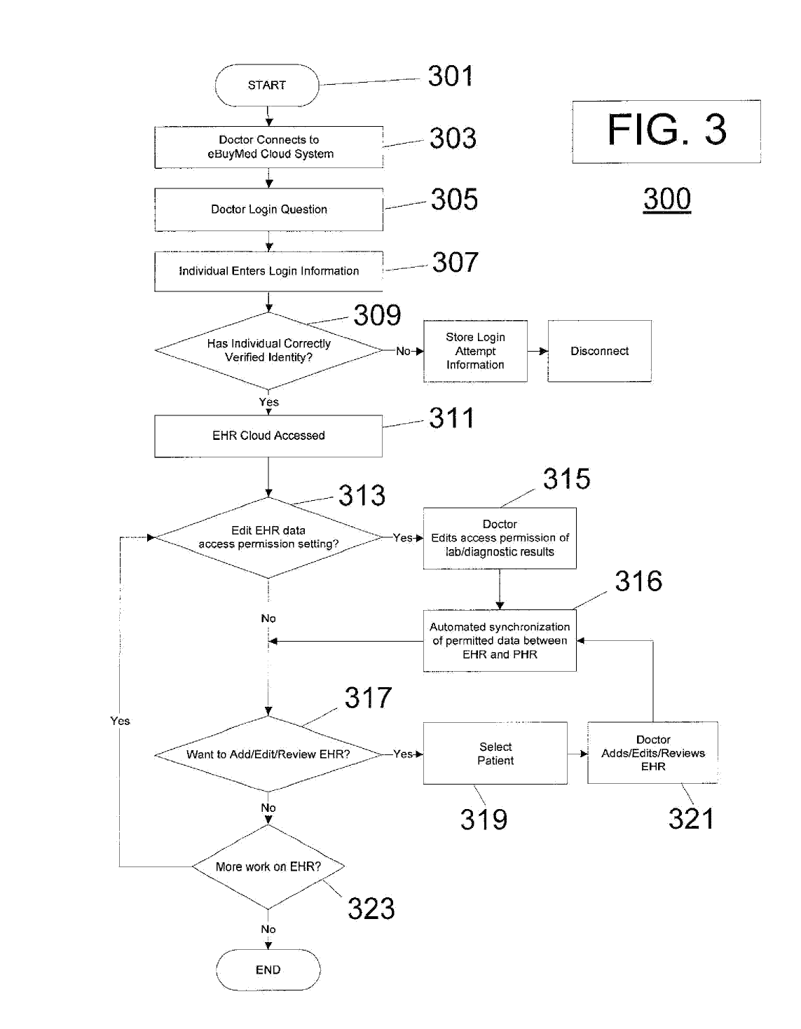

FIG. 3 is a flow chart of how the health care professional utilizes the computer system of the smart health care matching system. At block 301, a doctor connects to the smart health care matching system or eBuyMed system by utilizing the health care professional computer system 103 (FIG. 1) that utilizes the internet 111 and authentication system to the EHR cloud 105. At block 303, the health care professional computer system 103 provides the health care professional 101a with a Login Question in order to allow the health care professional 101a to connect to the eBuyMed system 100. The Login question may be Username and Password, where health care professional 101a inputs his username and password that's authenticated by EHR cloud 105, then health care professional 101a is allowed to continue. The health care professional 101a utilizes the health care professional computer system 103 to connect through the Internet 111 to log onto the web interface 112 in EHR/PHR cloud system 104. Web interface 112 conducts authentication and allows profile update, view/edit full PHR entries and view partial EHR permission setting.

At block 305, the health care professional 101a accesses the EHR cloud 105. The health care professional 101 sets permissions setting through permission based sharing server 107 for PHR records of PHR cloud 113—and EHR records of EHR cloud 105 information sharing. At block 307, the health care professional 101a utilizes the computer 103 to enter her individual login information that is transmitted through the Internet 111 and web interface 112 to the EHR/PHR cloud system 104. The login information may include the health care professional's first name, middle name, last name, type of doctor, date registered as a doctor and any other useful information. At block 309, the EHR cloud server 105 determines if the individual identity is correctly identified. EHR cloud server 105 compares login information with stored login information to see if there is a match. If the individual is not correctly identified then this individual login information is stored at EHR record data at EHR cloud server 105 then this process ends.

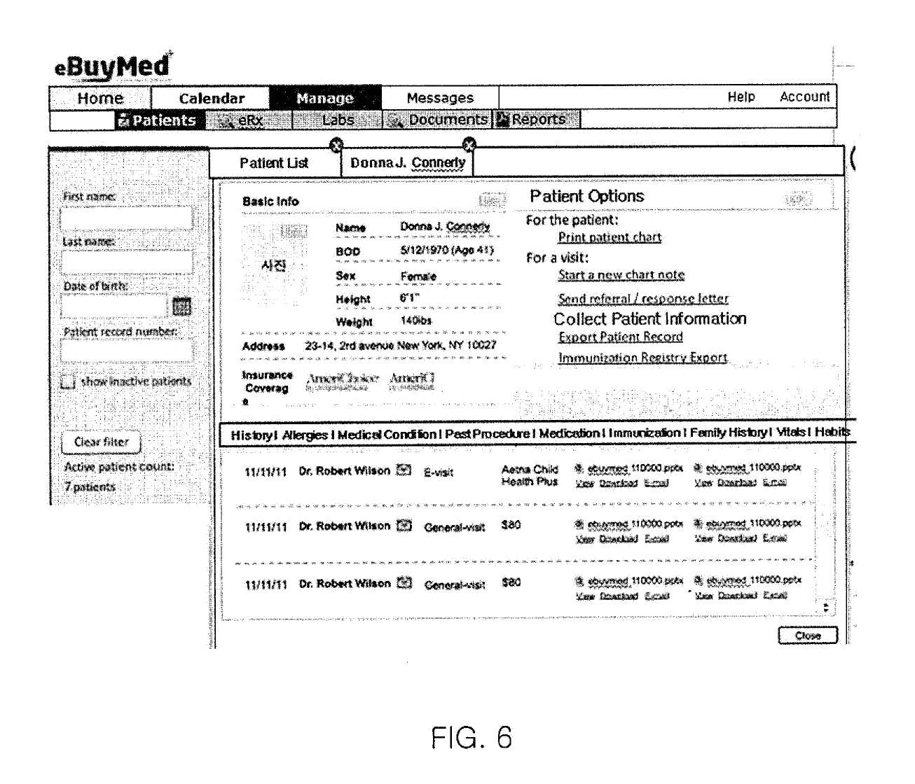

If the individual login information is correctly identified, then this process continues to block 311. At block 311 the EHR cloud 105 is accessed. Next, at block 313, there is a determination if EHR data in EHR cloud 105 should be edited based on access permission setting from permission based sharing server 107 that may limit information that can be accessed and edited. The EHR data may include the information on web page of FIG. 6 that includes the first and last name of the patient, date of birth, sex, height, weight, address, type of insurance, pass medical history and times the patient visited the health care professional.

If there is a determination that the EHR records should be edited then at block 315 the health care professional 101a is given permission to edit lab or diagnostic results of the EHR records. The edit of the lab or diagnostic results may be referred to as a modification of lab or diagnostic results. Next, at block 316 there will be an automatic synchronization of permitted data as dictated by the permission based server 107. Permission based server 107 dictates how much of the edited lab/diagnostic results of the EHR records at EHR cloud 105 is shared with the PHR records at PHR cloud 113.

However, if it is determined that there should be no edit of EHR records at EHR cloud 105 then the process continues to block 317. At block 317, there is a determination to add, edit or review EHR records at EHR cloud 105. If there is a want to add, edit or review EHR records at EHR cloud 105, then the health care professional 101a selects a patient at block 319. In this example, one patient is selected to have her information/records from EHR records stored on EHR cloud server 105 added, edited or reviewed but two or more patients may have their information/records from EHR records stored on EHR cloud server 105 added, edited or reviewed. The adding or editing of the EHR records may be referred to as a modification or modifying of the EHR records at EHR cloud server 105. The modified EHR record may include a modified drug description, modified general diagnosis of a disease or physical condition of the patient, recent procedures done for the patient and allergies the patient may have.

Next, at block 321 the health care professional 101a adds, edits or reviews (“modifies”) the patient's or patients' EHR record at EHR cloud 105 then the process goes to block 316. At block 316, there is an automatic synchronization of permitted data as dictated by the permission based server 107. Permission based server 107 dictates how much of the patient's added, edited or reviewed EHR records at EHR cloud 105 are shared with PHR records at PHR cloud 113 then the process goes to block 317. While at block 317 the data shared in the EHR records at EHR cloud 105 is also synchronized with the health care professional computer system 101. Also, at block 317 the data shared in the PHR records at PHR cloud 113 is synchronized with the patient computer system 115. However if there is not a want to add, edit or review a patient's EHR record stored on EHR cloud 105 then the process continues to block 323.

At block 323, there is a determination if there is need to perform more work on EHR records at EHR cloud server 105. If there is more work to perform on EHR records at EHR cloud server 105 then the process returns to block 313. However, if there is no more work to perform on the EHR record stored on EHR cloud 105 then the process ends.

This invention provides an integrated computer system that matches a patient with the most appropriate health care professional. This computer system enables the patient to be securely and easily predicted or matched with the most appropriate health care based on the patient's criteria, electronic health records, personal health records and a matching server that includes a smart health care matching system application program. This smart health care system application program utilizes a Machine learning program with the electronic health records, personal health records and the patient's criteria to provide the most predicted or appropriate health care professional for the patient's needs.

Although the present invention has been described above in terms of specific embodiments, many modifications and variations of this invention can be made as will be obvious to those of ordinary skill in the art, without departing from its spirit and scope as set forth in the following claims.

What is claimed is:

1. An integrated computerized health care prediction system:
a patient computerized system is connected through a web interface to a matching server, wherein the matching server is configured to receive a selection criteria from a patient at the patient computerized system;
the matching server is connected to an electronic health (EHR) cloud server having electronic health records and a personal health record (PHR) cloud server having personal health records of a patient;
the matching server is configured to receive the selection criteria from the patient computerized system, wherein the matching server includes a smart health care matching system application program; and
the matching server is configured to utilize the selection criteria, the electronic health records, the personal health records with the smart health care matching system application program to predict a health care professional appropriate for the patient.

2. The integrated computerized system of claim 1, wherein the matching server is configured to predict a plurality of health care professionals and/or insurance plans for the patient.

3. The integrated computerized system of claim 1, wherein the personal health records includes: a history of a disease of the patient, a history of past procedures, a history of medication, a history of immunization, a history of family history, vitals, habits, allergies, a history of medical condition, insurance coverage if any, a history of doctor appointments of the patient, a preference of doctors for the patient, a home address for the patient and a patient budget.

4. The integrated computerized system of claim 1, wherein the electronic health records includes services offered by the doctor comprising fever, cold, heart disease and contacts.

5. The integrated computerized system of claim 1, wherein the selection criteria includes patient medical insurance information and type of patient service requested.

6. The integrated computerized selection system of claim 1 wherein the selection criteria include type of health care professional requested.

7. The integrated computerized selection system of claim 6, wherein the health care professional is a general practitioner.

8. The integrated computerized selection system of claim 6, wherein the health care professional is a dermatologist.

9. The integrated computerized selection system of claim 6, wherein the healthcare professional is an obstetrician.

10. The integrated computerized selection system of claim 1 wherein the smart health care application program includes a rating system.

11. The integrated computerized selection system of claim 10 wherein the rating system is in a range of 0 to 5.

12. A computer-implemented method of updating health care records, comprising:
providing an electronic health record on an electronic health record cloud;
providing a health care professional access to the electronic health record on the electronic health record cloud;
determining at a health care professional computer system if the electronic health record at the electronic health record cloud should be modified for at least one patient by the health care professional;
providing authorization from a permission based server to the health care professional with permission to modify the electronic health record of the at least one patient;
modifying the electronic health record of the at least one patient through the health care professional computer system; and
automatically synchronizing the modified electronic health record based on permitted data allowed by the permission based server between the electronic record on the electronic health record cloud and a personal health record of the personal health record cloud.

13. The method of claim 12, wherein the modified electronic health record includes a drug prescription, general diagnosis, procedures done and allergies.

14. The method of claim 12, wherein the selection criteria includes the type of doctor, type of information.

15. The method of claim 12, further comprises automatically synchronizing the modified electronic health record with an electronic health record on the health care professional computer system.

16. The method of claim 12, further comprises automatically synchronizing the modified electronic health record with a personal health record on a patient computer system.

17. A computer-implemented method of updating health care records, comprising:
providing a personal health record on a personal health record cloud;
providing a patient with access to the personal health record on the personal health record cloud;
determining at a patient health care computer system if the personal health record at the personal health record cloud should be modified for the patient;
modifying the personal health record of the patient through the patient health care computer system; and
automatically synchronizing the modified personal health record with a a personal health record on the patient health care computer system.
